(19) United States
(12) Patent Application Publication
(10) Pub. No.: US 2015/0143252 A1
(43) Pub. Date: May 21, 2015

(54) Apparatuses, Methods, And Computer Program Products For An Interactive Experience

(71) Applicant: Studio 9 Labs, Inc., Dover, DE (US)

(72) Inventors: Skip Longfellow, Los Angeles, CA (US); Brian Keith Hendriks, Los Angeles, CA (US); Warren Keith Hendriks, Encino, CA (US)

(73) Assignee: Studio 9 Labs, Inc., Dover, DE (US)

(21) Appl. No.: 14/086,173

(22) Filed: Nov. 21, 2013

(51) Int. Cl. G06F 3/0484

(52) U.S. Cl. CPC G06F 3/04842
USPC 715/744

(57) ABSTRACT

Various methods, apparatuses, and computer program products are provided. For example, a processing apparatus may be configured to determine whether to initiate a data session with a user equipment (UE) based on information provided by the UE, determine whether one or more input signals provided by the UE during the data session are associated with an interactive segment of the interactive experience, and select a next segment of the interactive experience based on the one or more input signals associated with the interactive segment of the interactive experience.

### BACKGROUND

Media may include one or more segments. A non-limiting example of media is a movie. A movie may include one or more segments, and each segment may have a portion of the movie. In existing systems, various features (e.g., content, sequence, chronology, timing, and/or duration) of the media may be pre-determined (e.g., pre-programmed or pre-selected). However, viewers may desire to interact with the media in order to affect such features. Accordingly, there exists a need in the art for interactivity with media.

### SUMMARY

Methods, apparatuses, and computer program products are provided. In an aspect, a method may include determining whether to initiate a data session with a user equipment (UE) based on information provided by the UE, determining whether one or more input signals provided by the UE during the data session are associated with an interactive segment of the interactive experience, and selecting a next segment of the interactive experience based on the one or more input signals associated with the interactive segment of the interactive experience.

In an aspect, an apparatus may include a means for deter mining whether to initiate a data session with a UE based on information provided by the UE, a means for determining whether one or more input signals provided by the UE during the data session are associated with an interactive segment of the interactive experience, and a means for selecting a next segment of the interactive experience based on the one or more input signals associated with the interactive segment of the interactive experience.

In another aspect, an apparatus may include a memory and at least one processor associated with the memory and configured to determine whether to initiate a data session with a UE based on information provided by the UE, determine whether one or more input signals provided by the UE during the data session are associated with an interactive segment of the interactive experience, and select a next segment of the interactive experience based on the one or more input signals associated with the interactive segment of the interactive experience.

In an aspect, a computer program product may include a computer-readable medium comprising code for determining whether to initiate a data session with a UE based on information provided by the UE, code for determining whether one or more input signals provided by the UE during the data session are associated with an interactive segment of the interactive experience, and code for selecting a next segment of the interactive experience based on the one or more input signals associated with the interactive segment of the interactive experience.

Other aspects of apparatuses, methods, and computer program products described herein will become readily apparent to those skilled in the art based on the following detailed description, wherein various aspects of apparatuses and methods are shown and described by way of illustration. Such aspects may be used in many different forms and its details may be modified in various ways without deviating from the scope of the present disclosure. Accordingly, the drawings and detailed description provided herein are to be regarded as illustrative in nature and not as restricting the scope of the claims.

### BRIEF DESCRIPTION OF THE DRAWINGS

FIG. 1 is a diagram illustrating an example implementation in a theater.

FIG. 2 is a diagram illustrating an example implementation in a sport arena.

FIG. 3 is a diagram illustrating an example implementation in a viewing area.

FIG. 4 is a diagram illustrating an example of various segments of media.

FIGS. 5-7 are diagrams illustrating examples of communications between a processing apparatus and UEs at various times.

FIGS. 8-14 are flow charts illustrating examples of various methods.

FIG. 15 is a conceptual data flow diagram illustrating an example of a data flow between different modules/means/components in a processing apparatus.

FIG. 16 is a diagram illustrating an example of a hardware implementation for a processing apparatus utilizing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

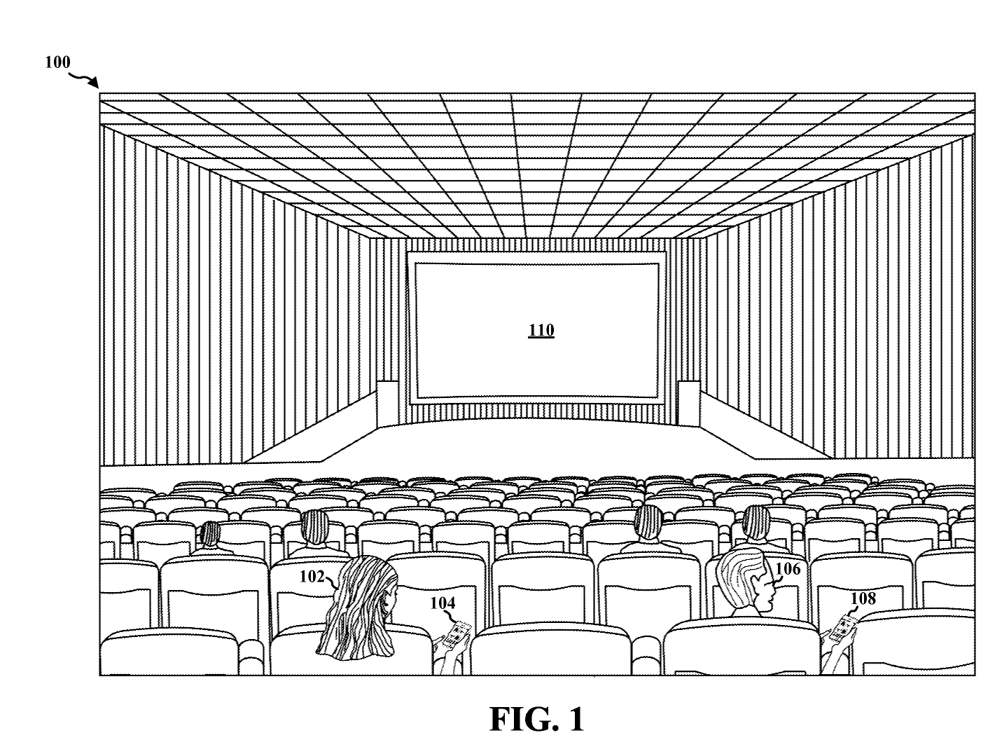

FIG. 1 is a diagram illustrating an example implementation in a theater 100. The theater 100 may be configured to display the interactive experience on the screen 110. For example, the interactive experience may be a movie (e.g., a motion picture), a trailer (e.g., a movie trailer), a pre-show screening, pre-show advertisements, a post-show screening, a video, one or more images, a game, a gaming interface, or any type or form of media. The segments may each have various characteristics (e.g., content, sequence, chronology, timing, and/or duration). The viewers 102, 106 may affect one or more of the characteristics of a segment using the UEs 104, 108 as described in further detail infra.

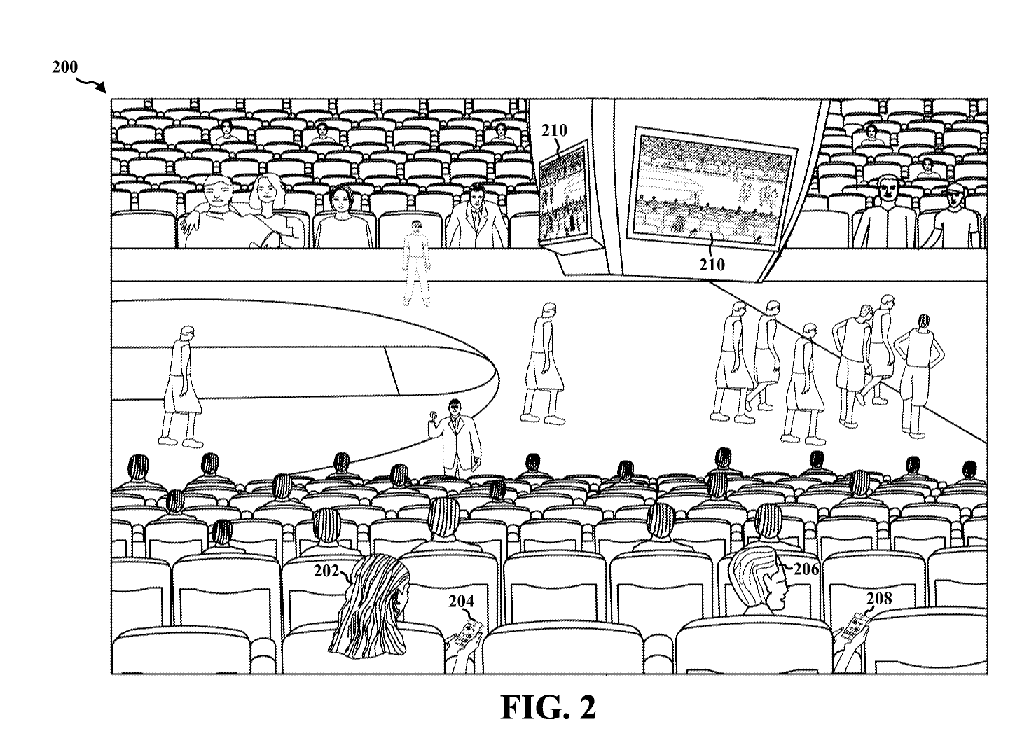

FIG. 2 is a diagram illustrating an example implementation in a sport arena 200. The sport arena 200 may be configured to display the interactive experience on the screen 210. For example, the interactive experience may be an advertisement, any type of video, one or more images, or any other type of suitable media. The segments may have various characteristics (e.g., content, sequence, chronology, timing, and/or duration). The viewers 202, 206 may affect one or more of the characteristics of a segment using the UEs 204, 208 as described in further detail infra.

Examples of UEs 104, 108, 204, 208 may include a cellular phone, a smart phone, a session initiation protocol (SIP) phone, a laptop, a personal digital assistant (PDA), a multimedia device, a video device, a cam era, a tablet, or any other similar functioning device. The UEs 104, 108, 204, 208 may also be referred to by those skilled in the art as a mobile station, a subscriber station, a mobile unit, a subscriber unit, a wireless unit, a remote unit, a mobile device, a wireless device, a wireless communications device, are mote device, a mobile subscriber station, an access terminal, a mobile terminal, a wireless terminal, a remote terminal, a handset, a user agent, a mobile client, a client, or some other suitable terminology. The UEs 104, 108, 204, 208 may be provided by the viewers 102, 106, 202, 206 (e.g., each viewer brings their own UE). Alternatively, the UEs 104, 108, 204, 208 may be provided to the viewers 102, 106, 202, 206 by the establishment (e.g., the theater or sport arena provides the UE to the viewer).

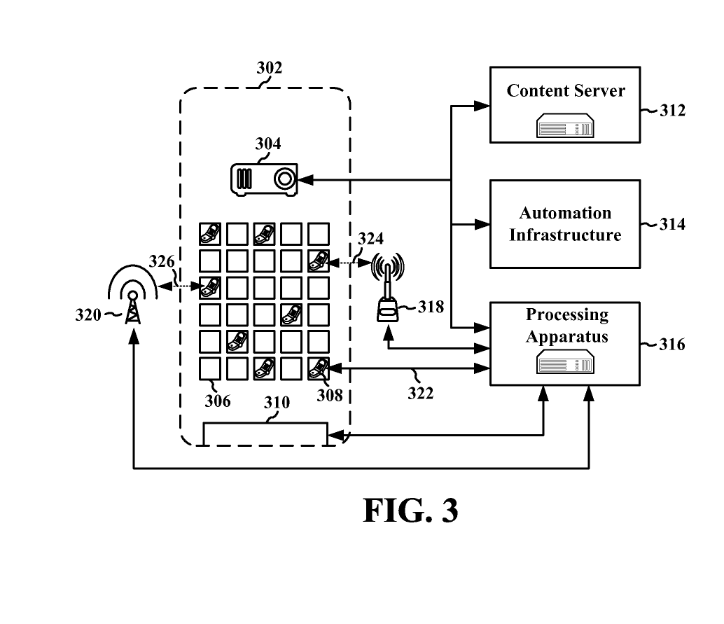

FIG. 3 is a diagram illustrating an ex ample implementation in a viewing area 302. The viewing area 302 may have seats 306 for viewers. At least some of the viewers may have access to a UE 308. The viewing area 302 may also have a screen 310 configured for display. In some configurations, segments may be projected onto the screen 310 using the projector 304. The projector 304 may display the segments according to data received from the content server 312 and/or the processing apparatus 316. In some configurations, the segments may be displayed on the screen 310 according to data provided to the screen 310 from the content server 312 and/or the processing apparatus 316.

The content server 312 may have at least one processor and at least one memory module configured to store and retrieve digital/electronic versions of various segments. The data may be provided to the content server 312 via a wireless connection (e.g., WiFi, WiMAX, 4 G/LTE, 3G, CDMA, etc.), a wired connection (e.g., Local Area Network), and/or a hard drive that may be inserted/installed into the content server 312. Because alternative methods of providing the data to the content server 312 will be readily apparent to one of ordinary skill in the art, the method of providing the data to the content server 312 as described herein shall not be construed as a limiting embodiment of the present disclose.

The automation infrastructure 314 may have at least one processor and at least one memory module configured to control various characteristics of the lighting of the viewing area 302, the sound of the viewing area 302, and/or other elements of the infrastructure of the viewing area 302.

The processing apparatus 316 may have at least one processor and at least one memory module configured to receive data/signals/information from the UEs 308 and to determine the segment to be displayed on the screen 310 based on the received data. In some configurations, the data may be received from the UEs 308 via a wired connection 322. In some configurations, the data may be received from the UEs 308 via a wireless connection 324, 326. For ex ample, the data may be received from the UEs 308 via a wireless connection 324 with a wireless network 318 (e.g., WiFi, WiMAX, etc.). As another example, the data may be received from the UEs 308 via a wireless connection 326 with a cellular network 320 (e.g., 4G/LTE, 3G, CDMA, etc.). In some configurations, the data may be received from the UEs 308 via a combination of a wired connection 322 and one or more of the wireless connections 324, 326. Additional description of processes performed by the processing apparatus 316 is provided infra.

One of ordinary skill in the art will appreciate that the example implementation described with respect to FIG. 3 is not limited to any particular environment. For example, the viewing are a 302 may be a local environment, such as a home environment, an office environment, a retail environment, or any other suitable environment. Viewers in the local environment may use UEs 308 to communicate with the processing apparatus 316. In some configurations, the processing apparatus 316 may be located inside of the local environment, and the content server 312 may be included outside of the local environment. For example, the content server 312 may provide media streaming from a remote location via a wired or wireless connection to the processing apparatus 316, which may be located inside of the local environment. In some configurations, the processing apparatus 316 and the content server 312 may be located outside of the local environment. In some configurations, the content server 312 and the processing apparatus 316 may be located inside of the local environment. In some configurations, such as when the content server 312 and the processing apparatus 316 are both located inside of or outside of the local environment, the content server 312 and the processing apparatus 316 may be parts of the same device.

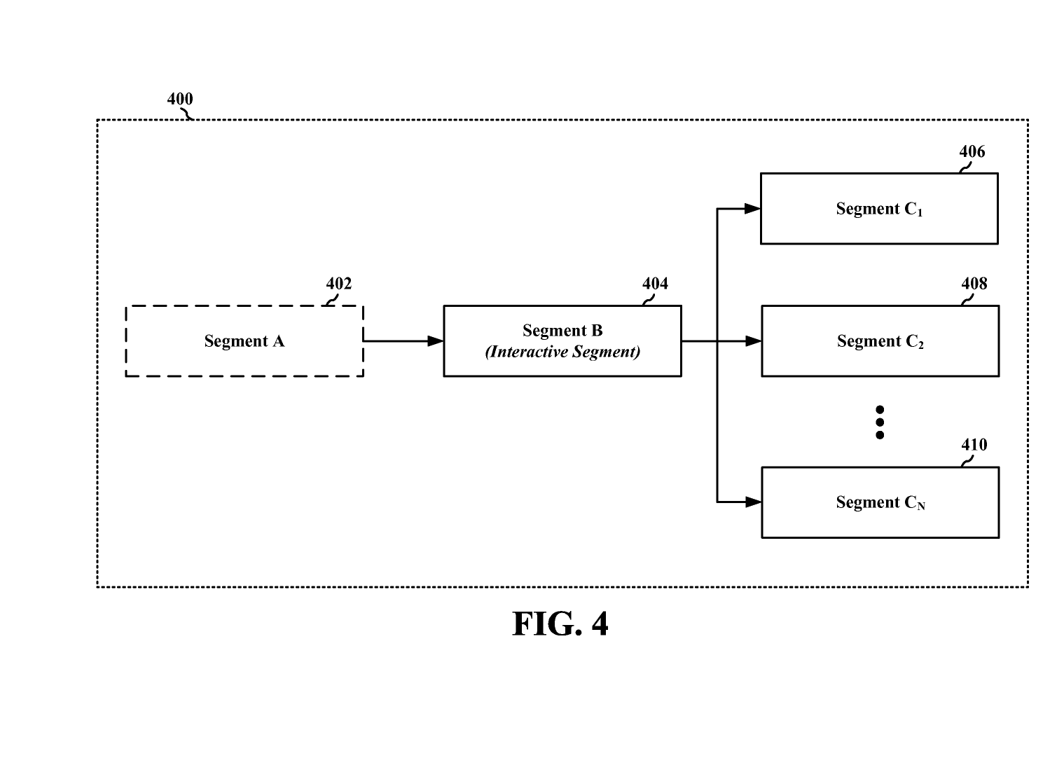

FIG. 4 is a diagram illustrating an example of various segments of media 400. The media 400 may have many more segments than the number of segments illustrated in FIG. 4. The method described with respect to FIG. 4 may be performed by the processing apparatus 316 (see FIG. 3) or any other apparatus or computer-readable medium configured to perform such methods. The media 400 may have an interactive segment (e.g., Segment B 404). The interactive segment (e.g., Segment B 404) may follow another segment (e.g., Segment A 402), which may or may not also be an interactive segment. The interactive segment (e.g., Segment B 404) may prompt the viewer to pro vide one or more inputs associated with various possible segments that can follow that interactive segment. The segment that follows the interactive segment (e.g., Segment C₁ 406, Segment C₂ 408, . . . , Segment C_{N} 410) may be selected based on the one or more inputs provided by the viewer(s).

For example, Segment A 402 may be a video segment showing a character traveling on a path that splits in different directions. Segment B 404 may be a video segment prompting the viewer to provide one or more inputs regarding the particular path that the viewer prefers for the character to travel. Each of the possible paths that the character may travel corresponds to a different video segment. For example, Segment C₁ 406 may show a video of events that transpire if the character travels on a first path, and Segment C₂ 408 may show a video of events that transpire if the character travels on a second path. The next segment selected is among Segment C₁ 406, Segment C₂ 408, . . . , Segment C_{N} 410 based on the one or more inputs provided by the viewer(s).

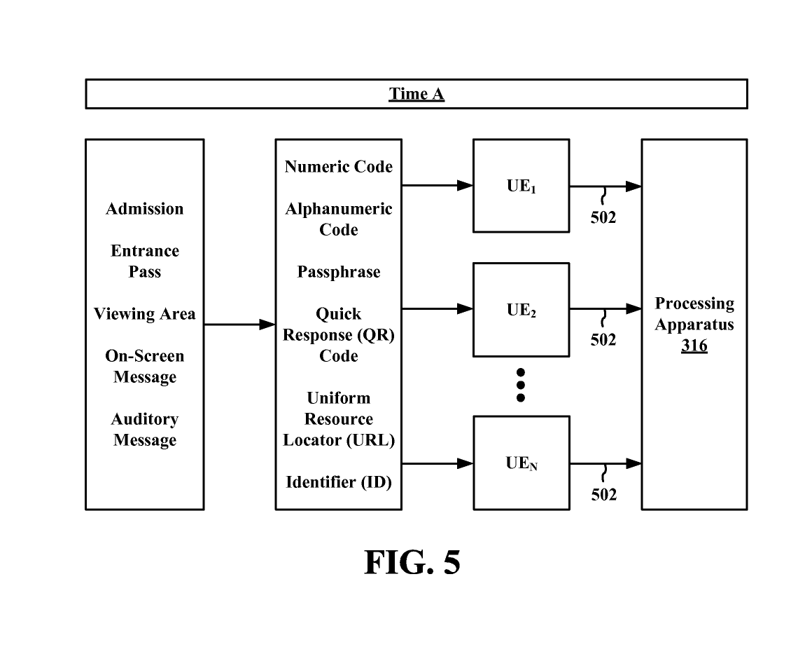

FIG. 5 is a diagram illustrating information 502 transmitted by UEs and received by the processing apparatus 316. At Time A, the processing apparatus 316 may receive information 502 from at least UE₁, UE₂, and UE_{N}. The information 502 may be an identifier associated with a particular interactive experience. For example, the identifier may be a numeric code, an alpha-numeric code, a passphrase, a quick response (QR) code, a uniform resource locator (URL), a screening identification (ID), a movie ID, a theater ID, a cinema ID, a home ID, a venue ID, an event ID, or any other suitable information. Based on the information 502 received from the UE, the processing apparatus 316 may determine whether to initiate a data session with the UE. The identifier may be obtained from an admission ticket, an entrance pass, a viewing area, an on-screen message, an auditory message, or any other suitable source.

After the processing apparatus 316 receives the information 502, the processing apparatus 316 may determine whether to initiate a data session with each UE based on the information 502 received from that UE. The processing apparatus 316 may determine to initiate a data session with the UE when the information 502 provided by the UE satisfies certain data session parameters. The processing apparatus 316 may refrain from initiating a data session with the UE when the information 502 provided by the UE does not satisfy data session parameters. Generally, the data session parameters may determine whether the UE is associated with a particular interactive experience. More specifically, the data session parameters may be associated with an identity of the interactive experience, a viewing area of the interactive experience, an address corresponding to the interactive experience, a show time of the interactive experience, or any other suitable aspect of the interactive experience. For example, the data session parameters are not satisfied when the UE provides information 502 associated with a different interactive experience in a different viewing area 302. However, data session parameters may be satisfied when the UE provides information 502 associated with that particular interactive experience.

In the example illustrated in FIG. 5, the processing apparatus 316 receives information 502 from at least UE₁, UE₂, and UE_{N}. The processing apparatus 316 determines to initiate data sessions with at least UE₁, UE₂, and UE_{N}. Although not illustrated in FIG. 5, it will be understood by one of ordinary skill in the art that the processing apparatus 316 may refrain from initiating a data session with one or more UEs. For example, if the QR code provided by a UE does not satisfy certain data session parameters, then the processing apparatus 316 may refrain from initiating a data session parameter with that particular UE.

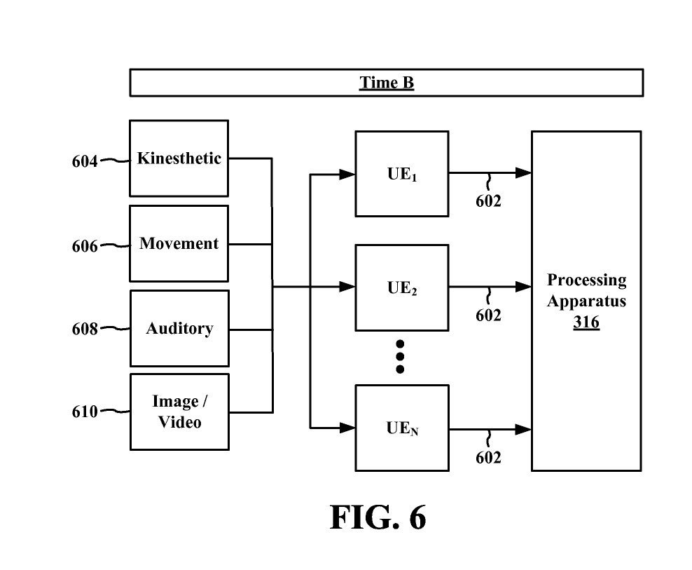

FIG. 6 is a diagram illustrating one or more input signals 602 transmitted by UEs and received by the processing apparatus 316 after the data session has been initiated. At Time B, the UEs with which the processing apparatus 316 has initiated a data session may provide one or more input signals 602 to the processing apparatus 316. Because data sessions were initiated with at least UE₁, UE₂, and UE_{N}, the processing system 316 may receive one or more input signals 602 from at least UE₁, UE₂, and/or UE_{N}. The processing apparatus 316 may determine whether the one or more input signals 602 are associated with an interactive segment of the interactive experience. For example, referring back to FIG. 4, the processing apparatus 316 may determine whether the one or more input signal 602 received from at least UE₁, UE₂, and UE_{N} are associated with Segment B 404.

Based on the received one or more input signals 602 associated with the interactive segment (e.g., Segment B 404) of the interactive experience, the processing apparatus 316 may select a next segment of the interactive experience. For example, referring to FIG. 4, the processing system 316 may select one (or more) of Segment C₁ 406, Segment C₂ 408, . . . , Segment C_{N} 410 based on the one or more input signals 602 received during Segment B 404. As such, the one or more input signals 602 may be provided by at least UE₁, UE₂, and UE_{N} during a time period corresponding to the interactive segment (e.g., Segment B 404) of the interactive experience. In some configurations, the selection of the next segment of the interactive experience may include quantifying the one or more input signals 602 during a period of time and subsequently selecting the next segment of the interactive experience from one or more possible next segments according to the quantified one or more input signals 602.

The one or more input signals may be provided in various forms and implementations. Any reference provided herein with respect to specific examples of the one or more input signals 602 shall not be construed as a limitation of the present disclosure. In some configurations, the one or more input signals 602 may be associated with a kinesthetic input 604 provided to the UE. For example, the one or more input signals 602 may correspond to a vote, a grade, a score, one or more words, one or more letters, and/or one or more alphanumeric phrases provided to the UE. For instance, the viewer may cast a vote using the UE for one (or more) of the possible next segments (e.g., Segment C₁ 406, Segment C₂ 408, . . . , Segment C_{N} 410). Accordingly, the next segment may be selected based on the number of votes cast for each of the possible next segments.

As another example, the one or more input signals 602 may be received from the UE in response to an inquiry or puzzle presented during a portion of the interactive experience. For instance, the viewer may be presented with a puzzle or inquiry on the screen 310 (see FIG. 3) during a portion of the interactive experience (e.g., during Segment B 404 in FIG. 4). In response to viewing the inquiry or puzzle, the viewer may provide one or more inputs to the UE. Accordingly, processing apparatus 316 may receive one or more input signals from the UE in response to an inquiry or puzzle presented during a portion of the interactive experience. Accordingly, the next segment (e.g., Segment C₁ 406, Segment C₂ 408, Segment C_{N} 410) may be selected based on the responses provided to the UE in response to the puzzle or inquiry.

In some configurations, the one or more input signals 602 may be associated with a movement 606 of the UE. For example, the one or more input signals 602 may correspond to a degree of rotation, an amount of movement, a speed of movement, and/or an acceleration of movement of the UE. For instance, the viewer may move the UE in various directions and/or various speeds to indicate which one (or more) of the possible next segments (e.g., Segment C₁ 406, Segment C₂ 408, . . . , Segment C_{N} 410) that the viewer prefers. Accordingly, the next segment may be selected based on the degree of rotation, the amount of movement, the speed of movement, and/or the acceleration of movement of the UE with respect to each possible next segment.

In some configurations, the one or more input signals 602 may be associated with an auditory input 608 provided to the UE. For example, the viewer may speak into a microphone of the UE. In some embodiments, the one or more input signals 602 may be quantified based on a volume of the auditory input 608. For example, the processing apparatus 316 receiving one or more input signals 602 corresponding to speech may attribute a higher count to louder speech relative to quieter speech. In some other embodiments, the one or more input signals 602 may correspond to a correlation between a vocal input provided to the UE and one or more possible vocal inputs. For example, the view er may provide a vocal input (e.g., a speech signal) corresponding to a word or phrase (e.g., the phrase “path A”). The processing apparatus 316 may determine a correlation between the received vocal input (e.g., the speech signal of “path A”) and one or more possible vocal inputs (e.g., the speech signal of the phrase “path A,” the speech signal of the phrase “path B,” etc.). If the processing apparatus 316 determines that the received vocal input has the highest correlation to the speech signal of the phrase “path A,” then the processing apparatus 316 may determine that the one or more input signals 602 received from the UE correspond(s) to path A. Such determinations can be used to select the next segment (e.g., Segment C₁ 406, Segment C₂ 408, . . . , Segment C_{N} 410) of the interactive experience.

In some configurations, the one or more input signals 602 may be associated with an image/video 610 captured by the UE. For instance, the viewer may be shown a series of possible next segments, and the viewer may use the UE to capture an image or video of a ‘thumbs-up’ or a ‘thumbs-down’ as each of the possibilities are shown to the viewer. If the viewer is shown an image or text corresponding to Option A, the viewer may have a duration of time in which to capture an image or video of a ‘thumbs-up’ or ‘thumbs-down.’ Subsequently, the viewer may be shown an image or text corresponding to Option B, and the viewer may have a duration of time in which to capture an image or video of a ‘thumbs-up’ or ‘thumbs-down.’ The processing apparatus 316 may perform pattern recognition analysis to determine the content of the image or video captured by the UE (e.g., whether the image or video is a ‘thumbs-up’ or a ‘thumbs-down’). Such determinations can be used to select the next segment (e.g., Segment C₁ 406, Segment C₂ 408, . . . , Segment C_{N} 410) of the interactive experience.

As another example, the viewer may use the UE to capture an image or video of a facial gesture (e.g., the facial gesture of the viewer's own face or the facial gesture of another person). The image or video captured by the UE may be received by the processing apparatus 316. The processing apparatus 316 may use pattern recognition analysis to ascertain various characteristics of the captured facial gesture (e.g., a smile, a frown, etc.). For instance, the viewer may be shown an image or text corresponding to Option A, and the viewer may have a duration of time in which to capture an image or video of a facial gesture corresponding to Option A. Afterwards, the viewer may be shown an image or text corresponding to Option B, and the viewer may have a duration of time in which to capture a facial gesture corresponding to Option B. The processing apparatus 316 may perform pattern or facial recognition analysis to ascertain various characteristics of the facial gesture in the image or video captured by the UE (e.g., whether the facial gesture is a smile or a frown). Such determinations can be used to select the next segment (e.g., Segment C₁ 406, Segment C₂ 408, . . . , Segment C_{N} 410) of the interactive experience.

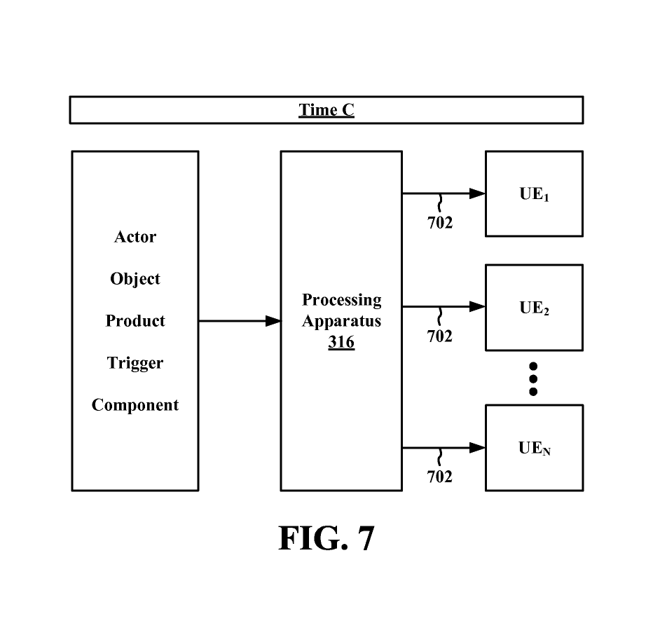

FIG. 7 is a diagram illustrating content 702 transmitted by the processing apparatus 316 and received by the UEs. At Time C, the processing apparatus 316 may transmit content 702 to at least UE₁, UE₂, and UE_{N}. The content 702 may be a message having text, an image, a URL, a webpage, a phone number, a haptic component (e.g., a vibration), and/or any other suitable data. In some configurations, the content 702 may correspond to an element of the interactive segment of the interactive experience, an element of a segment prior to the interactive segment of the interactive experience, or an element of the next segment of the interactive experience. For example, referring back to FIG. 4, the content 702 may correspond to an element in Segment A 402, an element in Segment B 404, and/or an element in any one (or more) of Segment C₁ 406, Segment C₂ 408, . . . , Segment C_{N} 410. The element may be an actor, an object, a product, a trigger, a component, or any other aspect of any segment of the interactive experience. For example, a product (e.g., a specific vehicle) in a segment (e.g., Segment A 402) of the interactive experience may trigger content 702 to be sent to the UE. The content 702 may include an image of the product (e.g., the specific vehicle) and the URL of the nearest location (e.g., car dealership) where that product may be purchased.

In some configurations, the time of the transmission of the content 702 from the processing apparatus 316 to the UE may not be based on (e.g., may be independent of) the time of receiving the one or more input signals 602 from the UE. For example, referring back to FIG. 6, the content 702 may be transmitted to the UE prior to the one or more inputs 602 being received by the processing apparatus 316. Also, for example, the processing apparatus 316 may transmit the content 702 to a UE with which a data session was never initiated. In some configurations, the transmission of the content 702 to the UE may be independent of the one or more input signals 602 received from the UE. As such, the content 702 may be transmitted irrespective of the one or more inputs 602 being received from the UE.

In some configurations, the transmission of the content to the UE is based on at least an element of the interactive segment of the interactive experience, an element of a segment prior to the interactive segment of the interactive experience, or an element of the next segment of the interactive experience. For example, a viewer may be shown a specific vehicle during a pre-show event (e.g., a movie trailer). At the same time or at some time thereafter, the processing apparatus 316 may transmit content to the UE based on an element of that particular segment. For instance, the content may be some form of advertisement, such as an image of that specific vehicle, or a website where the viewer can obtain more details about that specific vehicle. One of ordinary skill in the art will appreciate that the foregoing are non-limiting examples and alternative embodiments and implementations are with in the scope of the disclosure provided herein.

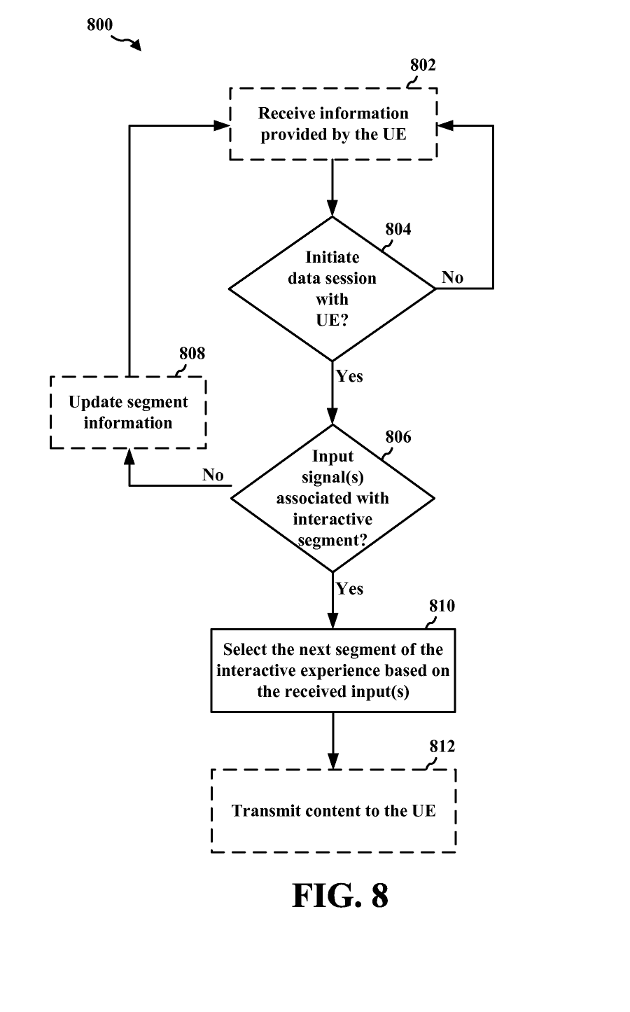

FIG. 8 is a flow chart illustrating an example of a method 800. In some configurations, the method 800 may be performed by the processing apparatus 316. At step 802, the processing apparatus 316 may receive information provided by a UE. The information may be an identifier associated with a particular interactive experience. For example, referring back to FIG. 5, the identifier may be a numeric code, an alpha-numeric code, a passphrase, a QR code, a URL, a screening ID, a movie ID, a theater ID, a cinema ID, a home ID, a venue ID, an event ID, or any other suitable information. The identifier may be included in an admission ticket, an entrance pass, a viewing area, an on-screen message, an auditory message, or any other suitable source.

At step 804, the processing apparatus 316 may determine whether to initiate a data session with the UE based on information provided by the UE. In some configurations, the processing apparatus 316 may refrain from initiating a data session with the UE when the information provided by the UE does not satisfy data session parameters. The data session parameters may be associated with an identity of at least the interactive experience, a viewing area of the interactive experience, an address corresponding to the interactive experience, or a show time of the interactive experience. If the processing apparatus 316 refrains from initiating a data session with the UE, then the processing apparatus 316 may proceed to step 802. The processing apparatus 316 may initiate a data session with the UE when the information provided by the UE satisfied data session parameters. If the processing apparatus 316 initiates a data session with the UE, then the processing apparatus 316 may proceed to step 806.

At step 806, the processing apparatus 316 may determine whether one or more input signals provided by the UE during the data session are associated with an interactive segment of the interactive experience. For example, referring back to FIG. 4, the processing apparatus 316 may determine whether the one or more input signals received during the data session are associated with Segment B 404, which is an interactive segment. Accordingly, in some configurations, the one or more input signals may be provided during a time period corresponding to the interactive segment (e.g., Segment B 404) of the interactive experience.

The one or more input signals may be provided in various forms and implementations without deviating from the scope of the present disclosure. Referring back to FIG. 6, the one or more inputs may be associated with a kinesthetic input 604, a movement 606, an auditory input 608, and/or an image/video 610 of the UE. In some configurations, the one or more input signals may correspond to at least a vote, a grade, a score, one or more words, one or more letters, or one or more alphanumeric phrases. In some configurations, the one or more input signals may correspond to at least a degree of rotation, an amount of movement, a speed of movement, or an acceleration of movement of the UE. In some configurations, the one or more input signals may correspond to an auditory input provided to the UE. In some configurations, the one or more input signals may correspond to a correlation between a vocal input provided to the UE and one or more possible vocal inputs. In some configurations, the one or more input signals are received in response to an inquiry or puzzle presented during a portion of the interactive experience. In some configurations, the one or more input signals may correspond to a content or characteristic of an image or video captured by the UE. For example, the characteristic of the video may include at least a direction of movement of an element in the video, a rate of movement of the element in the video, an acceleration of the element in the video, a pattern of movement of the element in the video, or a facial gesture or pattern in the video.

At step 806, the processing apparatus 316 may determine that the one or more input signals provided by the UE are not associated with the interactive segment of the interactive experience when the one or more input signals correspond to a segment information request. For example, the UE may send a segment information request to obtain updated information (e.g., timing information, length/duration information, etc.) about a particular segment of the interactive experience. As such, the segment information request is not associated with the interactive segment of the interactive segment. When the one or more input signals correspond to the segment information request, the processing apparatus 316 may proceed to step 808. At step 808, the processing apparatus 316 may update the UE with current segment information (e.g., timing information, length/duration information, etc.). After performing step 808, the processing apparatus 316 may proceed to step 802.

Alternatively, at step 806, the processing apparatus 316 may determine that the one or more input signals are associated with the interactive segment. If the processing apparatus 316 determines that the one or more input signals are associated with the interactive segment, the processing apparatus 316 may proceed to step 810. At step 810, the processing apparatus 316 may select the next segment of the interactive experience based on the received one or more in put signals associated with the interactive segment of the interactive experience. For example, referring back to FIG. 4, the processing apparatus 316 may select one (or more) of Segment C₁ 406, Segment C₂ 408, . . . , Segment C_{N} 410 based on the received one or more input signals associated with Segment B 404.

In some configurations, the processing apparatus 316 may select the next segment of the interactive segment by quantifying the one or more input signals during a period of time and subsequently selecting the next segment of the interactive experience from one or more possible next segments according to the quantified one or more input signals. For example, referring back to FIG. 4, the processing apparatus 316 may quantify the number of votes for Segment C₁ 406, Segment C₂ 408, . . . , Segment C_{N} 410. Based on the number of votes for Segment C₁ 406, Segment C₂ 408, . . . , Segment C_{N} 410, the processing apparatus 316 may select the next segment of the interactive experience. For instance, if Segment C₂ 406 received the greatest number of votes during the interactive segment (e.g., Segment B 404), then the processing apparatus 316 may select Segment C₂ 406 as the next segment of the interactive experience.

In some configurations, the processing apparatus 316 may transmit content to the UE. In the example illustrated in FIG. 8, the processing apparatus 316 transmits content to the UE at step 812. However, transmission of such content to the UE may be performed at any time and thus is not dependent up on any preceding step (e.g., steps 802, 804, 806, 808, 810). Accordingly, the time of the transmission of the content to the UE is not based on the time of the receiving of the one or more input signals from the UE. For example, the processing apparatus 316 may transmit content to the UE at time T₁ and subsequently receive the one or more input signals from the UE at time T₂, where T₂>T₁.

The content transmitted to the UE may correspond to an element of the interactive segment (e.g., Segment B 404) of the interactive experience, an element of a segment prior to the interactive segment (e.g., Segment A 402) of the interactive experience, or an element of the next segment (e.g., Segment C₁ 406, Segment C₂ 408, . . . , Segment C_{N} 410) of the interactive experience. For example, referring back to FIG. 7, such an element may include at least an actor, an object, a product, a trigger, or a component displayed during at least the interactive segment (e.g., Segment B 404) of the interactive experience, the segment prior to the interactive segment (e.g., Segment A 402) of the interactive experience, or the next segment (e.g., Segment C₁ 406, Segment C₂ 408, . . . , Segment C_{N} 410) of the interactive experience.

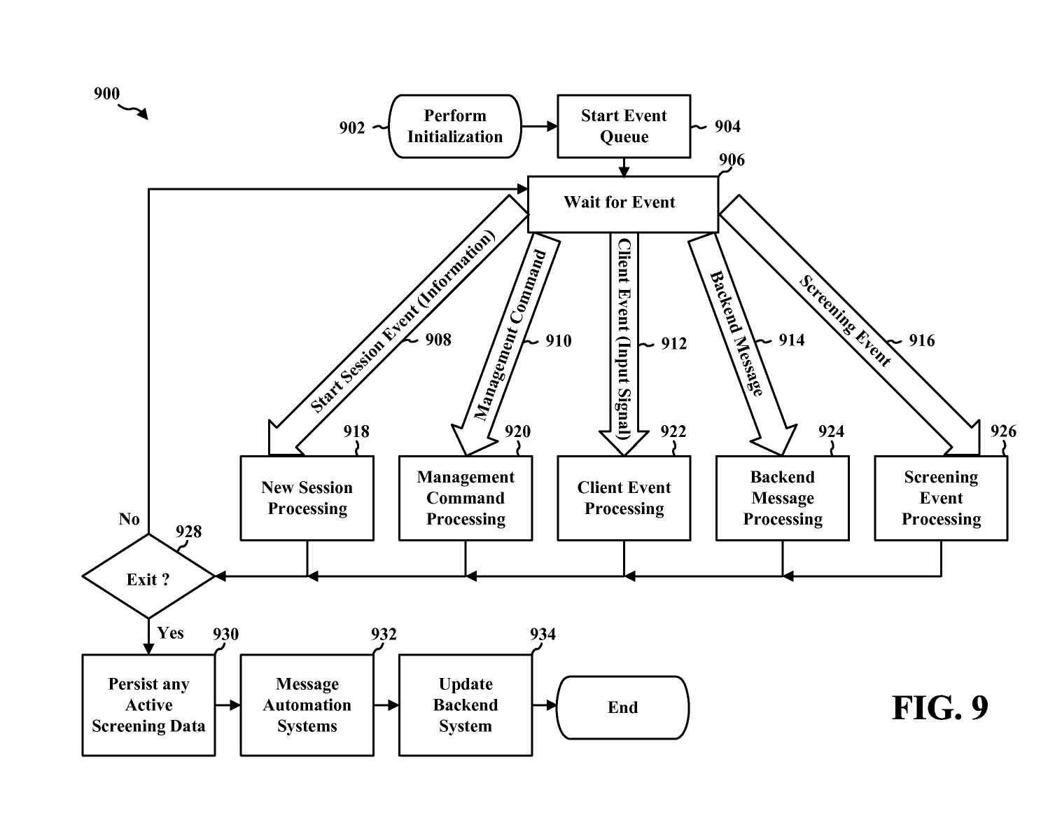

FIG. 9 is a flow chart illustrating an example of a method 900. The method 900 may be performed by the processing apparatus 316. The processing apparatus 316 may be a system that is configured to operate an event-driven software application. The event-driven software application may process events from user devices (e.g., UE(s)), an automation infrastructure 314, a playback system (e.g., content server 312), management tools, a backend system, and/or other internal processes. Events may be associated with various clients. One of ordinary skill in the art will appreciate that a ‘client’ may refer to the UE described supra. Also, one of ordinary skill in the art will appreciate that a ‘screening’ may refer to the inter active experience, or any segment thereof, as described supra.

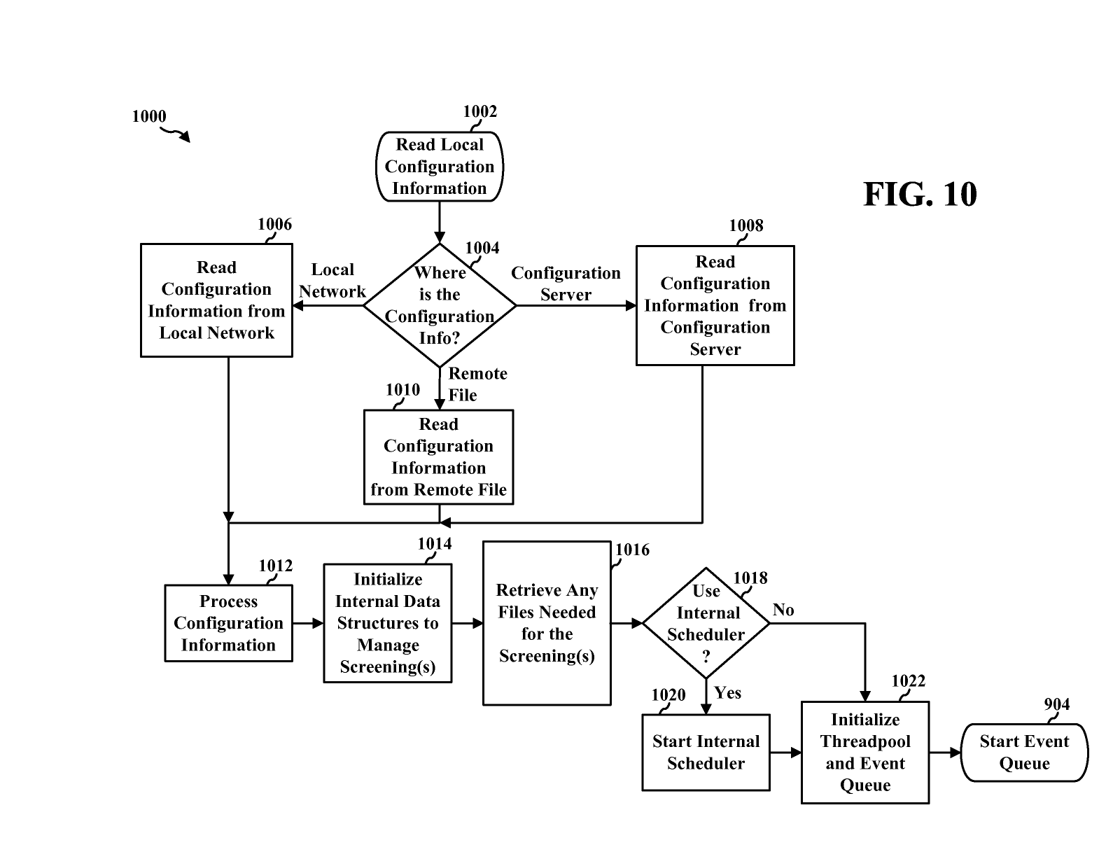

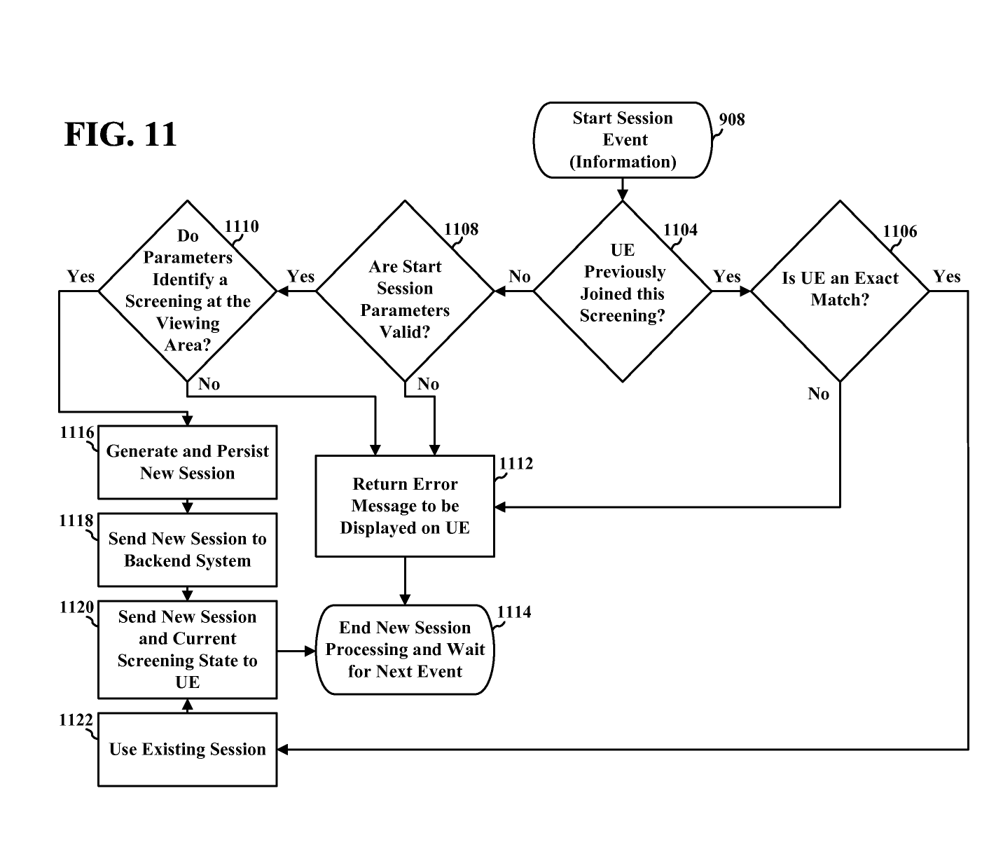

At step 902, the processing apparatus 316 may perform initialization. (With respect to step 902 in FIG. 9, additional description will be provided infra with reference to FIG. 10.) At step 904, the processing apparatus 316 may start an event queue. At step 906, the processing apparatus 316 may wait for an event. The event may be one or more of the following: ‘start session event’ 908 (e.g., the ‘information’ described supra), ‘management command’ 910, ‘client event’ 912 (the ‘one or more input signals’ described supra), ‘backend message’ 914, and/or ‘screening event’ 916. If the event is a ‘start session event’ 908, the processing apparatus 316 may perform new session processing at step 918. (With respect to step 918 in FIG. 9, additional description will be provided infra with reference to FIG. 11.) If the event is a ‘management command’ event 910, the processing apparatus 316 may perform management command processing at step 920. If the event is a ‘client event’ 912, then the processing apparatus 316 may perform client event processing at step 922. If the event is a ‘back end message’ 914, then the processing apparatus 316 may perform backend message processing at step 924. If the event is a ‘screening event’ 916, then the processing apparatus 316 may perform screening event processing at step 926.

At step 928, the processing apparatus 316 may determine whether to exit the event-driven software application. If the processing apparatus 316 determines not to exit, then the processing apparatus 316 may return to step 906 to wait for the next event. If the processing apparatus 316 determines to exit, then the processing apparatus 316 may persist any active screening data at step 930, send a message to automation systems at step 932, and update the backend system at step 934.

FIG. 10 is a flow chart illustrating an example of a method 1000. The method 1000 may be sub-steps performed in step 902 (in FIG. 9) for performing initialization. The method 1000 may be performed by the processing apparatus 316. At step 1002, the processing apparatus 316 may read local configuration information. At step 1004, the processing apparatus 316 may determine the location of the configuration information. If the configuration information is located in a local network, the processing apparatus 316 proceeds to step 1006 to read the configuration information from the local network. If the configuration information is located in a configuration server, the processing apparatus 316 may proceed to step 1008 in order to read the configuration information from the configuration server. If the configuration information is located in a remote file, the processing apparatus 316 may proceed to step 1010 to read the configuration information from the remote file.

After the configuration information is read, the processing apparatus 316 may process the configuration information at step 1012, initialize internal data structures to manage one or more screenings at step 1014, and retrieve any files needed for the one or more screenings at step 1016. At step 1018, the processing apparatus 316 may determine whether to use an internal scheduler. If an internal scheduler is used, the processing apparatus 316 may start the internal scheduler at 1020. If an internal scheduler is not used, the processing apparatus 316 may initialize a threadpool and event queue at step 1022. After step 1022, initialization may be complete and the processing apparatus 316 may subsequently proceed to step 904 (see FIGS. 9 and 10) to start the event queue.

FIG. 11 is a flow chart illustrating an example of a method 1100. The method 1100 may be sub-steps performed in step 918 (see FIG. 9) for new session processing. The method 1100 may be performed by the processing apparatus 316. The processing apparatus 316 may receive a start session event 908, such as the ‘information’ described in greater detail supra. After receiving the start session event 908, the processing apparatus 316 may begin new session processing. At step 1104, the processing apparatus 316 may determine whether the UE previously joined a particular screening or interactive experience. If the UE previously joined the particular screening or interactive experience, at step 1106, the processing apparatus 316 may determine whether the UE is an exact match to the UE that previously joined the particular screening or interactive experience. If the processing apparatus 316 determines that the UE is not an exact match, then the processing apparatus 316 may return an error message to be displayed on the UE at step 1112 and end the new session processing and wait for the next event at step 1114. However, if the processing apparatus 316 determines that an exact match exists, then the processing apparatus may use an existing session at step 1122, send session and current screening state to the UE at step 1120, and end the new session processing and wait for the next event at step 1114.

If, at step 1104, the processing apparatus 316 determines that the UE did not previously join that screening or interactive experience, then the processing apparatus 316 may proceed to step 1108 to determine whether the start session parameters are valid. If the start session parameters are not valid, then the processing apparatus 316 may return an error message to be displayed on the UE at step 1112 and end the new session processing and wait for the next event at step 1114. However, if the start session parameters are valid, then the processing apparatus 316 may proceed to step 1110 to determine whether the parameters identify a screening or interactive experience at a particular viewing area. If the parameters do not identify a screening or interactive experience at the particular viewing area, then the processing system 316 may return an error message to be displayed on the UE at step 1112 and end the new session processing and wait for the next event at step 1114. However, if the parameters identify a screening at the particular viewing area, then the processing apparatus 316 may generate and persist a new session at step 1116, send the new session to the backend system at step 1118, send the new session and the current screening state to the UE at step 1120, and end the new session processing and wait for the next event at step 1114.

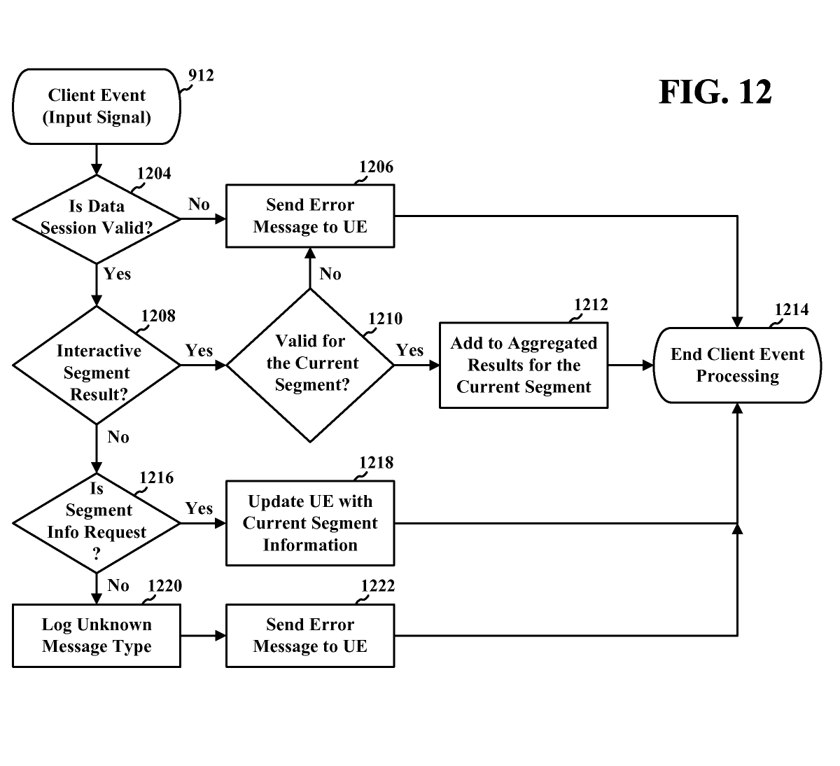

FIG. 12 is a flow chart illustrating an example of a method 1200. The method 1200 may be sub-steps performed in step 922 (in FIG. 9) for client event processing. The method 1200 may be performed by the processing apparatus 316. At step 912, the processing system 316 may receive the client event, such as the ‘one or more input signals’ described in greater detail supra. At step 1204, the processing apparatus 316 may determine whether the data session is valid. If the data session is not valid, the processing apparatus 316 may send an error message to the UE at step 1206 and end client event processing at step 1214. However, if the data session is valid, the processing apparatus 316 may determine whether the client event is an interactive segment result at step 1208. If the client event is an interactive segment result, then the processing apparatus 316 may determine whether the client event is valid for the current segment at step 1210. If the client event is not valid for the current segment, then the processing apparatus 316 may send an error message to the UE at step 1206 and end the client event processing at step 1214. However, if the client event is valid for the current segment, then the processing system 316 may add the client event to aggregated results for the current segment at step 1212 and end the client event processing at step 1214.

If, at step 1208, the processing apparatus 316 determines that the client event is not an interactive segment result, then the processing apparatus proceeds to step 1216. At step 1216, the processing apparatus 316 may determine whether the client event is a segment information request. If the client event is a segment information request, then the processing apparatus 316 may update the UE with current segment information at step 1218. However, if the client event is not a segment information request, then the processing apparatus 316 may log the unknown message type at step 1220, send an error message to the UE at step 1222, and end the client event processing at step 1214.

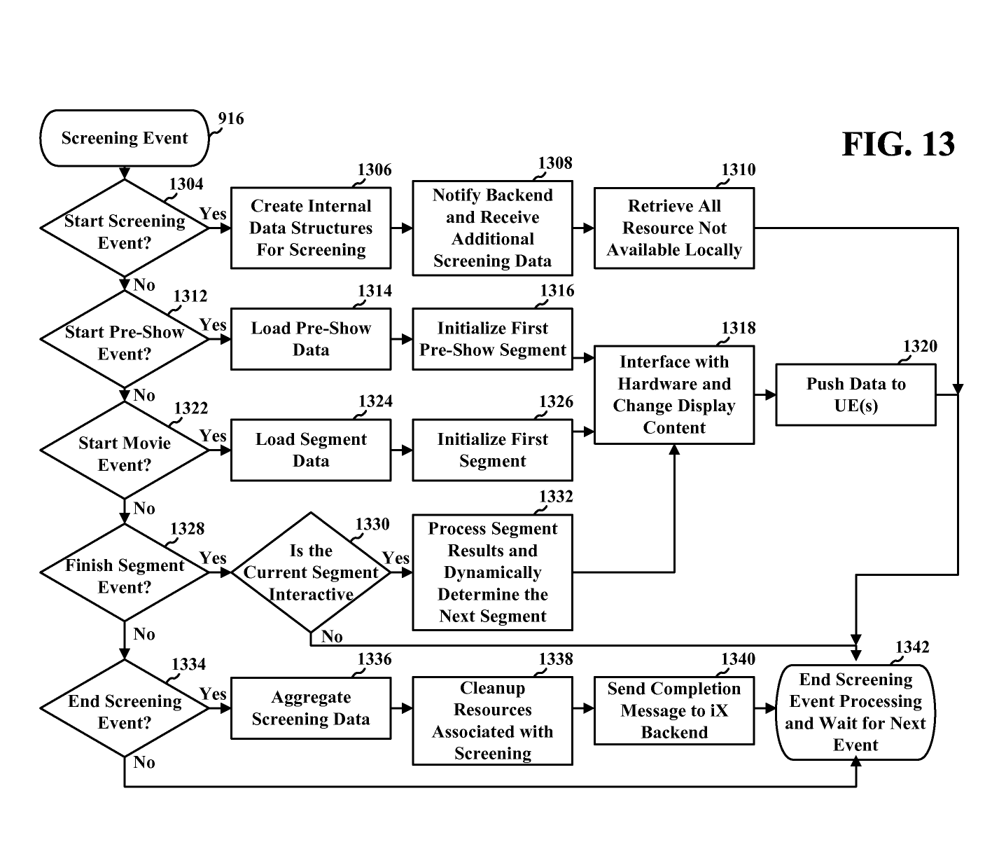

FIG. 13 is a flow chart illustrating an example of a method 1300. The method 1300 may be sub-steps performed in step 926 (see FIG. 9) for screening event processing. The method 1300 may be performed by the processing apparatus 316. The processing system 316 may receive the screening event 916. At step 1304, the processing apparatus 316 may determine whether the screening event 916 is a start screening event. If the screening event is a start screening event, then the processing apparatus 316 may create internal data structures for screening at step 1306, notify the backend system and receive additional screening data at step 1308, retrieve all resources not available locally at step 1310, and end the screening event processing and wait for the next event at step 1342. If the screening event is not a start screening event, then the processing apparatus 316 may proceed to step 1312.

At step 1312, the processing apparatus 316 may determine whether the screening event is a start pre-show event. If the screening event is a start pre-show event, then the processing apparatus 316 may load the pre-show data at step 1314, initialize the first pre-show segment at step 1316, interface with hardware and change display content at step 1318, push data to one or more UEs at step 1320, and end the screening event processing and wait for the next event at step 1342. If the screening event is not a start pre-show event, the processing apparatus 316 may proceed to step 1322.

At step 1322, the processing apparatus 316 may determine whether the screening event is a start movie event. If the screening event is a start movie event, then the processing apparatus 316 may load segment data at step 1324, initialize the first segment at step 1326, interface with hardware and change display content at step 1318, push data to one or more UEs at step 1320, and end the screening event processing and wait for the next event at step 1342. If the screening event is not a start movie event, then the processing apparatus 316 may proceed to step 1328.

At step 1328, the processing apparatus 316 may determine whether the screening event is a finish segment event. If the screening event is a finish segment event, then the processing apparatus 316 may proceed to step 1330. At step 1330, the processing apparatus 316 may determine whether the current segment is interactive (e.g., whether the current segment is an interactive segment). If the current segment is interactive, then the processing apparatus 316 may process segment results and dynamically determine the next segment at step 1332, interface with hardware and change display content at step 1318, push data to the one or more UEs at step 1320, and end the screening event processing and wait for the next event at step 1342. However, if the current segment is not interactive, the processing apparatus 316 may proceed to step 1342 to end the screening event processing and wait for the next event. If the screening event is not a finish segment event, then the processing apparatus 316 may proceed to step 1334.

At step 1334, the processing apparatus 316 may determine whether the screening event is an end screening event. If the screening event is an end screening event, then the processing apparatus 316 may aggregate screening data at step 1336, cleanup resources associated with the screening at step 1338, send a completion message to the backend system at step 1340, and end the screening event processing and wait for the next event at step 1342. However, if the screening event is not an end screening event, then the processing apparatus 316 may proceed to step 1342 to end the screening event processing and wait for the next event.

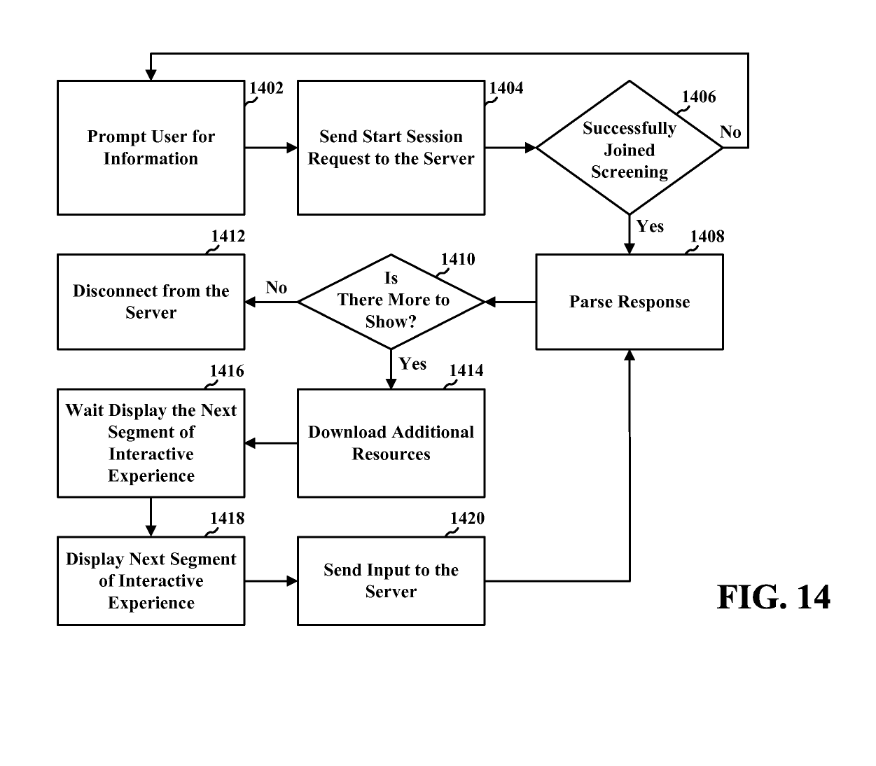

FIG. 14 is a flow chart illustrating an example of a method 1400. The method may be performed by a UE or client device, as described in additional detail supra. At step 1402, the UE may prompt the user of the UE for information. For example, such information may be the start session event described in greater detail supra with reference to FIGS. 9 and 10. At step 1404, the UE may send a start session request to a server. At step 1406, the UE may determine whether the UE has successfully joined the screening or inter active experience. If the UE has not successfully joined the screening or interactive experience, the UE may proceed to step 1402. If the UE has successfully joined the screening or interactive experience, the UE may proceed to step 1408. At step 1408, the UE may parse a response and subsequently proceed to step 1410. At step 1410, the UE may determine whether the screening or interactive experience has more to show. If the screening or interactive experience has no more to show, the processing apparatus 316 may disconnect from the server at step 1412. However, if the screening or interactive experience has more to show, then the processing apparatus 316 may download additional resources at step 1414, wait for the next segment of the screening or interactive experience at step 1416, and display the next segment of the screening or interactive experience at step 1418. At step 1420, the UE may send an input to the server and subsequently proceed to step 1408, as described supra.

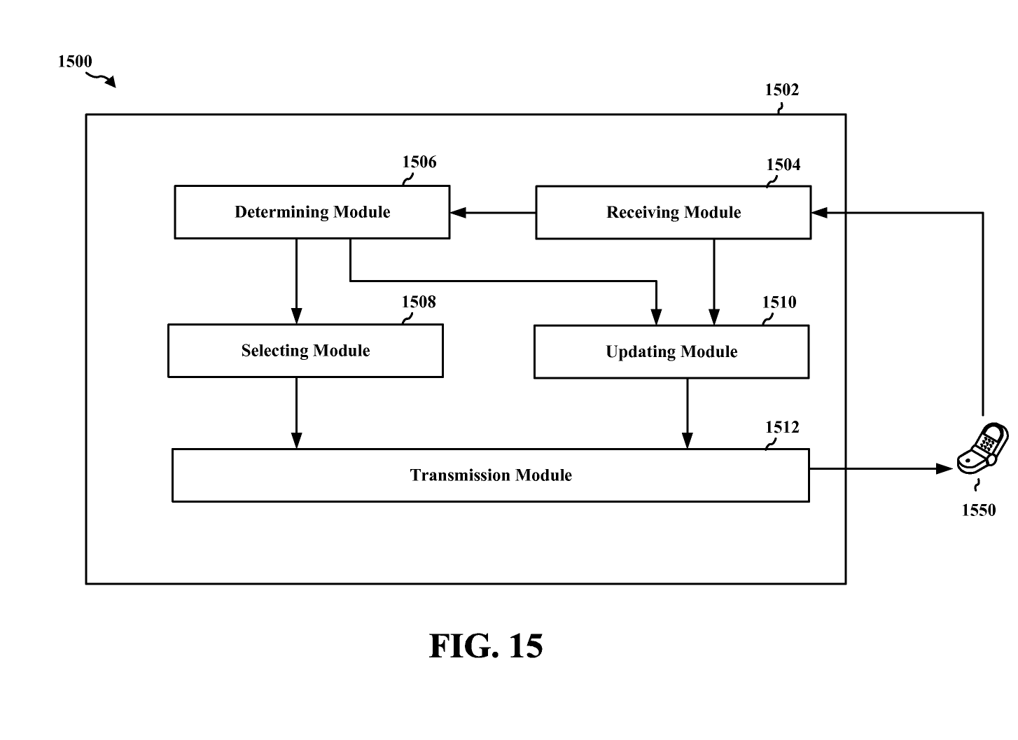

FIG. 15 is a conceptual data flow diagram 1500 illustrating the data flow between different modules/means/components in an example of the processing apparatus 1502. The processing apparatus 1502 may include a receiving module 1504, a deter mining module 1506, a selecting module 1508, an updating module 1510, and/or a transmission module 1512.

The processing apparatus 1502 may include additional modules that perform each of the steps of the algorithm in the aforementioned flow charts of FIGS. 8-14. As such, each step in the aforementioned flow charts of FIGS. 8-14 may be performed by a module and the processing apparatus 1502 may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

The receiving module 1504 may be configured to receive information. The determining module 1506 may be configured to determine whether to initiate a data session with a UE 1550 based on information provided by the UE 1550. The determining module 1506 may be further configured to determine whether one or more input signals provided by the UE 1550 during the data session are associated with an interactive segment of the interactive experience. In some configurations, the determining module 1506 may be further configured such that determining whether to initiate the data session with the UE 1550 includes initiating the data session when the information provided by the UE 1550 satisfies data session parameters and refraining from initiating the data session when the information provided by the UE 1550 does not satisfy the data session parameters.

The selecting module 1508 may be configured to select a next segment of the interactive experience based on the one or more input signals associated with the interactive segment of the interactive experience. In some configurations, the selecting module 1508 may be further configured such that selecting the next segment of the interactive experience includes quantifying the one or more input signals during a period of time and selecting a next segment of the interactive experience from one or more possible next segments according to the quantified one or more input signals.

The updating module 1510 may be configured to update the UE 1550 with current segment information when the one or more input signals correspond to a segment information request.

The transmission module 1512 may be configured to transmit content to the UE 1550. The content may correspond to an element of the interactive segment of the interactive experience, an element of a segment prior to the interactive segment of the interactive experience, or an element of the next segment of the interactive experience.

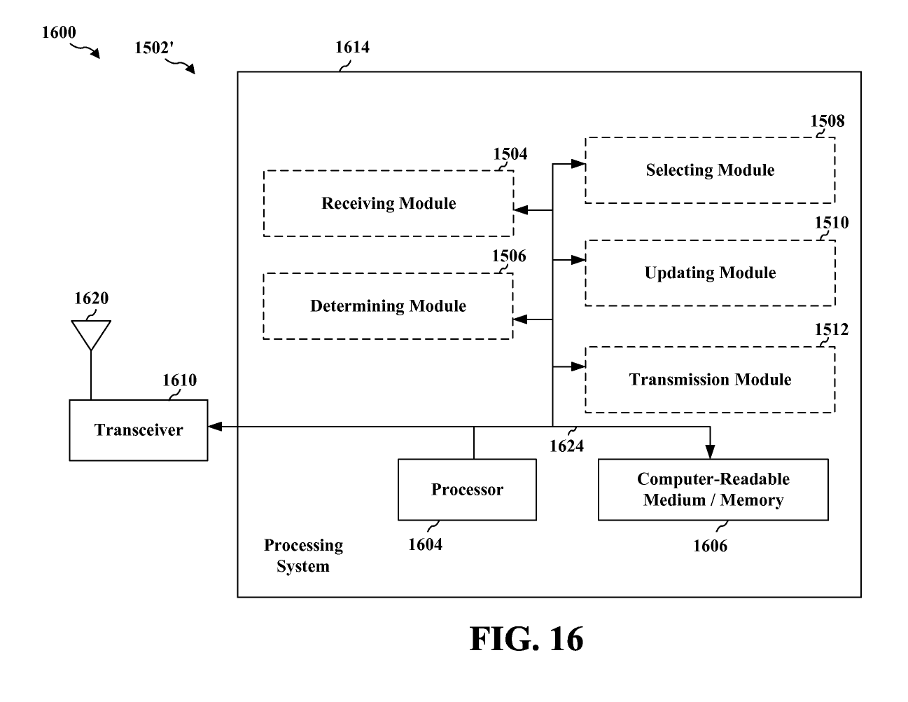

FIG. 16 is a diagram 1600 illustrating an example of a hardware implementation for a processing apparatus 1502′ utilizing a processing system 1614. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware modules, represented by the processor 1604, the modules 1504, 1506, 1508, 1510, 1512, and the computer-readable medium/memory 1606. The bus 1624 may also link various other circuits such as timing sources, peripherals, voltage regulators, and power management circuits, which are well known in the art.

The processing system 1614 may be coupled to a transceiver 1610. The transceiver 1610 is coupled to one or more antennas 1620. The transceiver 1610 provides a means for communicating with various other apparatuses over a transmission medium. The transceiver 1610 receives a signal from the one or more antennas 1620, extracts information from the received signal, and provides the extracted information to the processing system 1614, specifically the receiving module 1504. In addition, the transceiver 1610 receives information from the processing system 1614, specifically the transmission module 1512, and based on the received information, generates a signal to be applied to the one or more antennas 1620. The processing system 1614 includes a processor 1604 coupled to a computer-readable medium/memory 1606. The processor 1604 is responsible for general processing, including the execution of software stored on the computer-readable medium/memory 1606. The software, when executed by the processor 1604, causes the processing system 1614 to perform the various functions described supra for any particular apparatus. The computer-readable medium/memory 1606 may also be used for storing data that is manipulated by the processor 1604 when executing software. The processing system further includes at least one of the modules 1504, 1506, 1508, 1510, 1512. The modules may be software modules running in the processor 1604, resident/stored in the computer readable medium/memory 1606, one or more hardware modules coupled to the processor 1604, or some combination thereof. The processing system 1614 may be a component of the processing apparatus 316 and may include other memory and/or at least one other processor.

In some configurations, the processing apparatus 1502/1502′ provides and/or includes means for determining whether to initiate a data session with a UE based on information provided by the UE. In some configurations, the processing apparatus 1502/1502′ provides and/or includes means for determining whether one or more input signals provided by the UE during the data session are associated with an interactive segment of the interactive experience. In some configurations, the processing apparatus 1502/1502′ provides and/or includes means for selecting a next segment of the interactive experience based on the one or more input signals associated with the interactive segment of the interactive experience. In some configurations, the processing apparatus 1502/1502′ provides and/or includes means for initiating the data session when the information provided by the UE satisfies data session parameters. In some configurations, the processing apparatus 1502/1502′ provides and/or includes means for refraining from initiating the data session when the information provided by the UE does not satisfy the data session parameters. In some configurations, the processing apparatus 1502/1502′ provides and/or includes means for updating the UE with current segment information when the one or more input signals correspond to the segment information request. In some configurations, the processing apparatus 1502/1502′ provides and/or includes means for quantifying the one or more input signals during a period of time. In some configurations, the processing apparatus 1502/1502′ provides and/or includes means for selecting a next segment of the interactive experience from one or more possible next segments according to the quantified one or more input signals. In some configurations, the processing apparatus 1502/1502′ provides and/or includes means for transmitting content to the UE, the content corresponding to an element of the interactive segment of the interactive experience, a segment prior to the interactive segment of the interactive experience, or the next segment of the interactive experience.

The aforementioned means may be one or more of the aforementioned modules of the processing apparatus 1502 and/or the processing system 1614 of the processing apparatus 1502′ configured to perform the functions recited by the aforementioned means. As described supra, the processing system 1614 may include at least one processor. As such, in one configuration, the aforementioned means may be the at least one processor configured to perform the functions recited by the aforementioned means.

Several aspects of a system have been presented with reference to various apparatus, methods, and/or computer program products. Such apparatus, methods, and/or computer program products have been described in the detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media in eludes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not in tended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method comprising:
determining, by the server, whether one or more input signals provided by a user equipment (UE) are associated with an interactive segment, wherein the interactive segment comprises a portion of media displayed on a screen for an audience;
selecting, by the server, a segment following the interactive segment based on the one or more input signals associated with the interactive segment, wherein the segment following the interactive segment is displayed on the screen; and
transmitting, by the server, a message to be displayed on the UE, the message based on at least an actor, an object, or a product displayed on the screen during, prior to, or after the interactive segment.

2.-11. (canceled)

12. The method of claim 1, wherein the one or more input signals correspond to at least a degree of rotation, an amount of movement, a speed of movement, or an acceleration of movement of the UE.

13. The method of claim 1, wherein the one or more input signals correspond to an auditory input provided to the UE, the method further comprising quantifying the one or more input signals based on a volume of the auditory input.

14.-19. (canceled)

20. The method of claim 1, wherein the transmission of the content to be displayed on the UE is independent of the one or more input signals received from the UE.

21.-22. (canceled)

23. An apparatus comprising:
means for determining whether one or more input signals provided by a user equipment (UE) are associated with an interactive segment, wherein the interactive segment comprises a portion of media displayed on a screen for an audience;
means for selecting a segment following the interactive segment based on the one or more input signals associated with the interactive segment, wherein the segment following the interactive segment is displayed on the screen; and
means for transmitting a message to be displayed on the UE, the message based on at least an actor, an object, or a product displayed on the screen during, prior to, or after the interactive segment.

24. An apparatus comprising:
a memory; and
at least one processor associated with the memory and configured to:
determine whether one or more input signals provided by a user equipment (UE) are associated with an interactive segment, wherein the interactive segment comprises a portion of media displayed on a screen for an audience;
select a segment following the interactive segment based on the one or more input signals associated with the interactive segment, wherein the segment following the interactive segment is displayed on the screen; and
transmit a message to be displayed on the UE, the message based on at least an actor, an object, or a product displayed on the screen during, prior to, or after the interactive segment.

25. A non-transitory computer-readable medium comprising code for:
determining whether one or more input signals provided by a user equipment (UE) are associated with an interactive segment, wherein the interactive segment comprises a portion of media displayed on a screen for an audience;
selecting a segment following the interactive segment based on the one or more input signals associated with the interactive segment, wherein the segment following the interactive segment is displayed on the screen; and
transmitting a message to be displayed on the UE, the message based on at least an actor, an object, or a product displayed on the screen during, prior to, or after the interactive segment.

26.-27. (canceled)

28. The apparatus of claim 23, wherein the one or more input signals correspond to an auditory input provided to the UE, the apparatus further comprising means for quantifying the one or more input signals based on a volume of the auditory input.

29. The apparatus of claim 23, wherein the transmission of the content to be displayed on the UE is independent of the one or more input signals received from the UE.

30.-32. (canceled)

33. The apparatus of claim 24, wherein the one or more input signals correspond to an auditory input provided to the UE, wherein the at least one processor is further configured to quantify the one or more input signals based on a volume of the auditory input.

34. The apparatus of claim 24, wherein the transmission of the content to be displayed on the UE is independent of the one or more input signals received from the UE.

35.-37. (canceled)

38. The non-transitory computer-readable medium of claim 25, wherein the one or more input signals correspond to an auditory input provided to the UE, wherein the non-transitory computer-readable medium further comprises code for quantifying the one or more input signals based on a volume of the auditory input.

39. The non-transitory computer-readable medium of claim 25, wherein the transmission of the content to be displayed on the UE is independent of the one or more input signals received from the UE.

40. (canceled)

41.-56. (canceled)

57. The method of claim 1, wherein the transmitting the message to be displayed on the UE in response to at least an actor, an object, or a product displayed on the screen during, prior to, or after the interactive segment comprises transmitting a signal to trigger a haptic component of the UE, wherein the haptic component is triggered concurrently with the display of the message on the UE, wherein the haptic component comprises a vibration.

58. The method of claim 57, wherein the message to be displayed on the UE in response to at least an actor, an object, or a product displayed on the screen during, prior to, or after the interactive segment comprises an advertisement corresponding to at least an actor, an object, or a product displayed on the screen during, prior to, or after the interactive segment.

59. The method of claim 57, wherein the message to be displayed on the UE in response to at least an actor, an object, or a product displayed on the screen during, prior to, or after the interactive segment comprises a website or a uniform resource locator (URL) corresponding to at least an actor, an object, or a product displayed on the screen during, prior to, or after the interactive segment.

60. The method of claim 57, wherein the message to be displayed on the UE in response to at least an actor, an object, or a product displayed on the screen during, prior to, or after the interactive segment comprises an image or a video corresponding to at least an actor, an object, or a product displayed on the screen during, prior to, or after the interactive segment.

61. The apparatus of claim 23, wherein the transmitting the message to be displayed on the UE in response to at least an actor, an object, or a product displayed on the screen during, prior to, or after the interactive segment comprises transmitting a signal to trigger a haptic component of the UE, wherein the haptic component is triggered concurrently with the display of the message on the UE, wherein the haptic component comprises a vibration.

62. The apparatus of claim 61, wherein the message to be displayed on the UE in response to at least an actor, an object, or a product displayed on the screen during, prior to, or after the interactive segment comprises an advertisement corresponding to at least an actor, an object, or a product displayed on the screen during, prior to, or after the interactive segment.

63. The apparatus of claim 61, wherein the message to be displayed on the UE in response to at least an actor, an object, or a product displayed on the screen during, prior to, or after the interactive segment comprises a website or a uniform resource locator (URL) corresponding to at least an actor, an object, or a product displayed on the screen during, prior to, or after the interactive segment.

64. The apparatus of claim 61, wherein the message to be displayed on the UE in response to at least an actor, an object, or a product displayed on the screen during, prior to, or after the interactive segment comprises an image or a video corresponding to at least an actor, an object, or a product displayed on the screen during, prior to, or after the interactive segment.

65. The apparatus of claim 24, wherein the transmitting the message to be displayed on the UE in response to at least an actor, an object, or a product displayed on the screen during, prior to, or after the interactive segment comprises transmitting a signal to trigger a haptic component of the UE, wherein the haptic component is triggered concurrently with the display of the message on the UE, wherein the haptic component comprises a vibration.

66. The apparatus of claim 65, wherein the message to be displayed on the UE in response to at least an actor, an object, or a product displayed on the screen during, prior to, or after the interactive segment comprises an advertisement corresponding to at least an actor, an object, or a product displayed on the screen during, prior to, or after the interactive segment.

67. The apparatus of claim 65, wherein the message to be displayed on the UE in response to at least an actor, an object, or a product displayed on the screen during, prior to, or after the interactive segment comprises a website or a uniform resource locator (URL) corresponding to at least an actor, an object, or a product displayed on the screen during, prior to, or after the interactive segment.

68. The apparatus of claim 65, wherein the message to be displayed on the UE in response to at least an actor, an object, or a product displayed on the screen during, prior to, or after the interactive segment comprises an image or a video corresponding to at least an actor, an object, or a product displayed on the screen during, prior to, or after the interactive segment.

69. The non-transitory computer-readable medium of claim 25, wherein the transmitting the message to be displayed on the UE in response to at least an actor, an object, or a product displayed on the screen during, prior to, or after the interactive segment comprises transmitting a signal to trigger a haptic component of the UE, wherein the haptic component is triggered concurrently with the display of the message on the UE, wherein the haptic component comprises a vibration.

70. The non-transitory computer-readable medium of claim 69, wherein the message to be displayed on the UE in response to at least an actor, an object, or a product displayed on the screen during, prior to, or after the interactive segment comprises an advertisement corresponding to at least an actor, an object, or a product displayed on the screen during, prior to, or after the interactive segment.

71. The non-transitory computer-readable medium of claim 69, wherein the message to be displayed on the UE in response to at least an actor, an object, or a product displayed on the screen during, prior to, or after the interactive segment comprises a website or a uniform resource locator (URL) corresponding to at least an actor, an object, or a product displayed on the screen during, prior to, or after the interactive segment.

72. The non-transitory computer-readable medium of claim 69, wherein the message to be displayed on the UE in response to at least an actor, an object, or a product displayed on the screen during, prior to, or after the interactive segment comprises an image or a video corresponding to at least an actor, an object, or a product displayed on the screen during, prior to, or after the interactive segment.
